(19) United States
(12) Patent Application Publication
(10) Pub. No.: US 2026/0083538 A1
(43) Pub. Date: Mar. 26, 2026

(54) DENTAL CLEANING DEVICE AND HANDPIECE ASSEMBLY THEREOF

(71) Applicant: Dongguan Anbo Industries Co., Ltd., Dongguan (CN)

(72) Inventor: Zuping Xian, Dongguan (CN)

(21) Appl. No.: 19/406,891

(22) Filed: Dec. 2, 2025

(30) Foreign Application Priority Data
Aug. 20, 2025 (CN) 202511173592.1

(51) Int. Cl. A61C 17/22

(52) U.S. Cl. CPC A61C 17/225

(57) ABSTRACT

A handpiece assembly for a dental cleaning device includes a main body, a first rotating body, a second rotating body, and a cover. The main body includes a connection hole and a connection groove. The connection groove communicates with the connection hole and forms an opening. The first rotating body is rotatably disposed in the connection hole. The driven gear portion is meshed with the drive gear portion. The second shaft portion is disposed in the first shaft hole with a clearance fit. These arrangements allow the radial dimensions of the first shaft hole, the second shaft hole, the first shaft portion, and the second shaft portion to be much smaller than that of the connection groove, thereby reducing the contact friction area between the second rotating body and the main body, and consequently reducing heat generation and noise.

### CROSS REFERENCE TO RELATED APPLICATIONS

The present application claims the benefit of Chinese Patent Application No. 202511173592.1 filed on August 20, 2025, the contents of which are incorporated herein by reference in their entirety.

### FIELD OF THE INVENTION

The present invention relates to the technical field of dental cleaning devices, and in particular, to a dental cleaning device and a handpiece assembly thereof.

### BACKGROUND OF THE INVENTION

A dental polisher is used to clean and polish tooth surfaces to effectively prevent and treat dental diseases, which mainly consists of a protective angled handpiece and a high-speed rotation driver. The protective angled handpiece includes a housing, a polishing assembly, and a rotation assembly. The high-speed rotation driver drives the rotation assembly to rotate, and the rotation assembly drives the polishing assembly to rotate via transmission. The rotating polishing assembly contacts the tooth surfaces to achieve cleaning and polishing.

However, existing protective angled handpieces for dental polishers generally suffer from the problem of severe heat generation during operation. Referring to the angled handpiece structure for a polishing machine discussed in Chinese Patent No. CN202120810065.8, the radial dimension of the middle post of the polishing member is adapted to the radial dimension of the limit groove in the accommodation cavity of the housing. This results in a large contact friction area between the polishing member and the housing, leading to significant heat generation and high noise during the rotation of the polishing member.

### SUMMARY OF THE INVENTION

An object of the present invention is to provide a handpiece assembly for a dental cleaning device, which can reduce the contact friction area between the second rotating body and the main body, thereby reducing heat generation and noise during rotation of the second rotating body.

Another object of the present invention is to provide a dental cleaning device, wherein the handpiece assembly has a small friction area between the second rotating body and the main body, which is conducive to reducing heat generation and noise during rotation of the second rotating body.

To achieve the above objects, the present invention discloses a handpiece assembly for a dental cleaning device including: a main body, having a connection hole extending along a length direction thereof and a connection groove located at one end thereof, wherein the connection groove communicates with the connection hole and forms an opening facing one side of the main body, a middle portion of a bottom wall of the connection groove, which is away from the opening, is provided with a first shaft hole penetrating outwards; a first rotating body, rotatably disposed in the connection hole, wherein an end of the first rotating body facing the connection groove is provided with a drive gear portion; a second rotating body, including a limit portion, a first shaft portion, a second shaft portion, and a driven gear portion, wherein the first shaft portion and the second shaft portion are extended outwards from opposite ends of the limit portion respectively, the limit portion, the first shaft portion, and the driven gear portion are disposed in the connection groove, the limit portion is abutted against the bottom wall of the connection groove, the driven gear portion is meshed with the drive gear portion so that rotation of the first rotating body is transferred to the second rotating body with a changed direction, the second shaft portion is disposed in the first shaft hole with a clearance fit, and an end of the second shaft portion away from the limit portion is configured to connect to a dental cleaning member to drive the dental cleaning member to rotate; and a cover, fixedly mounted over the opening, wherein an inner wall of the cover is provided with a second shaft hole, and a terminal end of the first shaft portion is inserted into the second shaft hole with a clearance fit.

Preferably, a threaded hole is formed inwardly at the end of the second shaft portion away from the limit portion, a threaded post is extended outwardly from one end of the dental cleaning member and threadedly connected to the threaded hole, thereby connecting the dental cleaning member to the second shaft portion.

Preferably, the cover includes a first cover portion and a second cover portion, the second cover portion is extended from a middle part of one end of the first cover portion, and a middle part of an end of the second cover portion facing the connection groove is inwardly provided with the second shaft hole.

Preferably, a radial dimension of the opening is greater than a radial dimension of the connection groove, so that a limit surface is formed in the opening, the limit surface being orthogonally connected to both an inner side wall of the opening and an inner side wall of the connection groove.

Preferably, the second cover portion is adaptively inserted into an end of the connection groove away from the first shaft hole, and an edge of the first cover portion is abutted against the limit surface.

Preferably, the driven gear portion includes a plurality of driven teeth arranged around the first shaft portion at intervals on an end face of the limit portion facing the opening.

Preferably, the main body includes: a handle, including a first part and a second part extended along the length direction, wherein the first part is provided with a mounting groove, the second part includes a base portion connected to the first part and a boss extending upward from a middle part of an end of the base portion away from the first part, a first shoulder is formed between the boss and the base portion, the second part is provided with a first mounting hole extending along the length direction of the handle and penetrating through the base portion and the boss, and one end of the first mounting hole communicates with the mounting groove; and a housing, provided with a second mounting hole and the connection groove which penetrate outward in different directions and communicate with each other, wherein the boss is adaptively inserted into one end of the second mounting hole away from the connection groove, an end of a side wall of the housing defining the second mounting hole is disposed on the first shoulder; the mounting groove, the first mounting hole, and the second mounting hole, which communicate sequentially along the length direction of the main body, form the connection hole.

Preferably, the first rotating body includes a shaft portion and a head portion, the shaft portion is extended from a middle part of one end of the head portion, a second shoulder is formed between the head portion and the shaft portion, an end of the head portion away from the shaft portion forms the drive gear portion, the head portion is inserted into an end of the second mounting hole near the connection groove with a clearance fit, the second shoulder is abutted against an end face of the boss, and the shaft portion is disposed through the first mounting hole and the mounting groove with a clearance fit.

Preferably, the shaft portion includes a first cylindrical part and a second cylindrical part, one end of the first cylindrical part is connected to an end of the head portion away from the drive gear portion, another end of the first cylindrical part is connected to the second cylindrical part, and a radial dimension of the second cylindrical part is smaller than a radial dimension of the first cylindrical part.

Preferably, an axial dimension of the first mounting hole is greater than an axial dimension of the head portion.

Preferably, the end of the side wall of the housing defining the second mounting hole is fixedly connected to the base portion by seam welding.

Preferably, the first part includes a grip portion connected to the base portion, the mounting groove is provided at an end of the grip portion away from the base portion, and a radial dimension of said end of the grip portion is greater than a radial dimension of the base portion, and an outer side wall of an end of the grip portion connected to the base portion is formed with a transitional conical surface.

To achieve the above objects, the present invention discloses a dental cleaning device including the handpiece assembly mentioned above, a dental cleaning member connected to the second rotating body, and a drive assembly connected to the first rotating body, and the drive assembly being configured to drive the first rotating body to rotate.

Compared with the prior art, the main body of the present invention is provided with the connection hole and the connection groove. The bottom wall of the connection groove is provided with the first shaft hole penetrating outward. The connection groove communicates with the connection hole and forms the opening. The first rotating body is rotatably disposed in the connection hole. The limit portion, the first shaft portion, and the driven gear portion of the second rotating body are disposed in the connection groove. The driven gear portion of the second rotating body meshes with the drive gear portion of the first rotating body to transmit the rotation of the first rotating body to the second rotating body. The second shaft portion of the second rotating body is connected to the dental cleaning member to drive the dental cleaning member to rotate. The second shaft portion of the second rotating body is disposed in the first shaft hole with a clearance fit. The terminal end of the first shaft portion of the second rotating body is inserted into the second shaft hole of the cover, which is fixedly mounted over the opening, with a clearance fit. These arrangements allow the radial dimensions of the first shaft hole, the second shaft hole, the first shaft portion, and the second shaft portion to be much smaller than that of the connection groove, thereby reducing the contact friction area between the second rotating body and the main body, and consequently reducing heat generation and noise during rotation of the second rotating body.

### BRIEF DESCRIPTION OF THE DRAWINGS

FIG. 1 is a perspective view of a handpiece assembly for a dental cleaning device according to an embodiment of the present invention.

FIG. 2 is an exploded view of the handpiece assembly for a dental cleaning device according to an embodiment of the present invention.

FIG. 3 is a perspective view from another angle of FIG. 2.

FIG. 4 is a cross-sectional view of the handpiece assembly for a dental cleaning device according to an embodiment of the present invention.

### DETAILED DESCRIPTION OF ILLUSTRATED EMBODIMENTS

To detail the technical content and structural features of the present application, the following further describes the application in combination with embodiments and drawings.

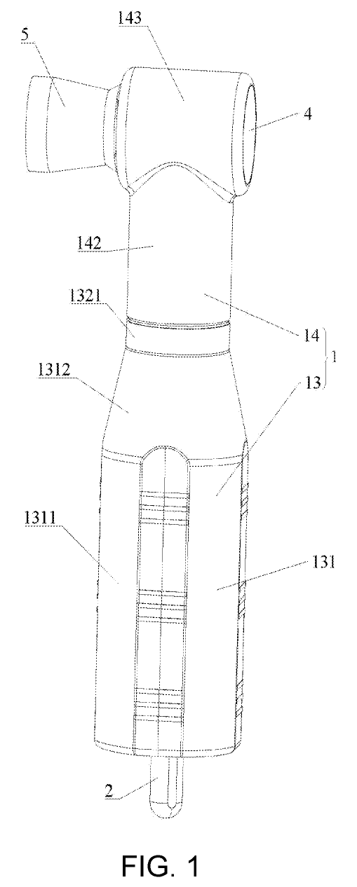

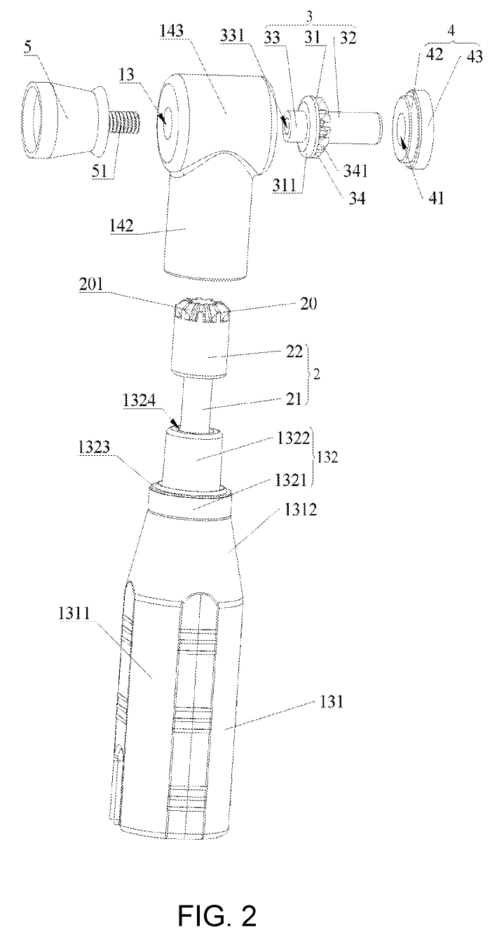

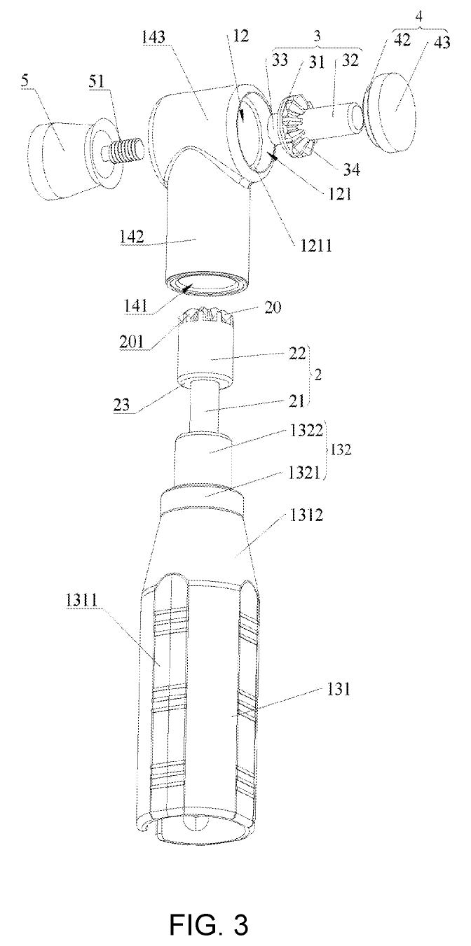

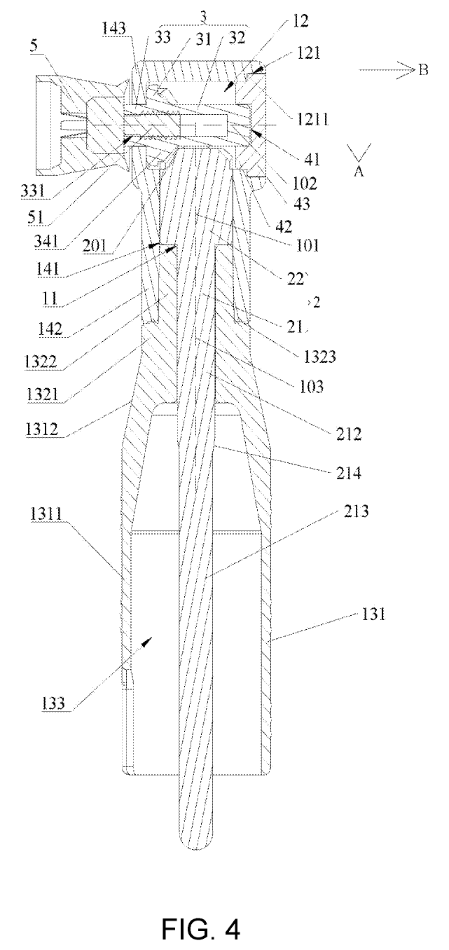

Referring to FIGS. 1 to 4, the present invention discloses a handpiece assembly for a dental cleaning device including a main body 1, a first rotating body 2, a second rotating body 3, and a cover 4.

The main body 1 is provided with a connection hole 11 extending along its length direction. One end of the main body 1 along the length direction is provided with a connection groove 12. The connection groove 12 communicates with the connection hole 11 and forms an opening 121 facing one side of the main body 1. A middle portion of a bottom wall of the connection groove 12, which is away from the opening 121, is provided with a first shaft hole 13 penetrating outwards.

The first rotating body 2 is rotatably disposed in the connection hole 11. An end of the first rotating body 2 facing the connection groove 12 is provided with a drive gear portion 20.

The second rotating body 3 includes a limit portion 31, a first shaft portion 32, a second shaft portion 33, and a driven gear portion 34. The first shaft portion 32 and the second shaft portion 33 are extended outwards from opposite ends of the limit portion 31, respectively. The limit portion 31, the first shaft portion 32, and the driven gear portion 34 are disposed in the connection groove 12. The limit portion 31 is abutted against the bottom wall of the connection groove 12. The driven gear portion 34 is meshed with the drive gear portion 20 so that the rotation of the first rotating body 2 is transferred to the second rotating body 3 with a changed direction. The second shaft portion 33 is disposed in the first shaft hole 13 with a clearance fit. An end of the second shaft portion 33 away from the limit portion 31 is configured to connect to a dental cleaning member 5 to drive the dental cleaning member 5 to rotate.

The cover 4 is fixedly mounted over the opening 121. An inner wall of the cover 4 is provided with a second shaft hole 41. A terminal end of the first shaft portion 32 is inserted into the second shaft hole 41 with a clearance fit.

Compared with the prior art, the main body 1 of the present invention is provided with the connection hole 11 and the connection groove 12. The bottom wall of the connection groove 12 is provided with the first shaft hole 13 penetrating outward. The connection groove 12 communicates with the connection hole 11 and forms the opening 121. The first rotating body 2 is rotatably disposed in the connection hole 11. The limit portion 31, the first shaft portion 32, and the driven gear portion 34 of the second rotating body 3 are disposed in the connection groove 12. The driven gear portion 34 of the second rotating body 3 meshes with the drive gear portion 20 of the first rotating body 2 to transmit the rotation of the first rotating body 2 to the second rotating body 3. The second shaft portion 33 of the second rotating body 3 is connected to the dental cleaning member 5 to drive the dental cleaning member 5 to rotate. The second shaft portion 33 of the second rotating body 3 is disposed in the first shaft hole 13 with a clearance fit. The terminal end of the first shaft portion 32 of the second rotating body 3 is inserted into the second shaft hole 41 of the cover 4, which is fixedly mounted over the opening 121, with a clearance fit. These arrangements allow the radial dimensions of the first shaft hole 13, the second shaft hole 41, the first shaft portion 32, and the second shaft portion 33 to be much smaller than that of the connection groove 12, thereby reducing the contact friction area between the second rotating body 3 and the main body 1, and consequently reducing heat generation and noise during rotation of the second rotating body 3.

Referring to FIGS. 1 to 4, in this embodiment, the limit portion 31, the first shaft portion 32, the second shaft portion 33 of the second rotating body 3, the first shaft hole 13 of the main body 1, and the second shaft hole 41 of the cover 4 are coaxially arranged. Due to the provision of the first shaft hole 13 and the second shaft hole 41, the radial dimensions of the first shaft portion 32 and the second shaft portion 33 can be set much smaller than the radial dimension of the connection groove 12, thereby effectively reducing the rotational friction area between the second rotating body 3 and the main body 1, and thus effectively reducing heat generation and noise during rotation of the second rotating body 3.

Referring to FIGS. 1 to 4, in this embodiment, an edge of the end of the limit portion 31 that abuts against the bottom wall of the connection groove 12 is provided with an arcuate surface 311, which helps reduce the contact area between the limit portion 31 and the bottom wall of the connection groove 12, thereby reducing heat generation during rotation of the second rotating body 3.

Referring to FIGS. 1 to 4, a threaded hole 331 is formed inwardly at the end of the second shaft portion 33 away from the limit portion 31. A threaded post 51 extends outwardly from one end of the dental cleaning member 5. The threaded post 51 is threadedly connected to the threaded hole 331, thereby connecting the dental cleaning member 5 to the second shaft portion 33 and facilitating the disassembly and replacement of the dental cleaning member 5.

Referring to FIGS. 1 to 4, the cover 4 includes a first cover portion 42 and a second cover portion 43. The second cover portion 43 extends from a middle part of one end of the first cover portion 42, and a middle part of an end of the second cover portion 43 facing the connection groove 12 is inwardly provided with the second shaft hole 41. A radial dimension of the opening 121 is greater than a radial dimension of the connection groove 12, so that a limit surface 1211 is formed in the opening 121. The limit surface 1211 is orthogonally connected to both an inner side wall of the opening 121 and an inner side wall of the connection groove 12. The second cover portion 43 is adaptively inserted into an end of the connection groove 12 away from the first shaft hole 13. An edge of the first cover portion 42 abuts against the limit surface 1211. The provision of the second cover portion 43 is conducive to the quick and stable installation of the first cover portion 42 into the opening 121.

Specifically, in this embodiment, the second shaft hole 41 formed in the second cover portion 43 is a blind hole. A radial dimension of the second cover portion 43 is consistent with the radial dimension of the connection groove 12, so that an outer side wall of the second cover portion 43 closely fits against the inner side wall of the connection groove 12, and the second cover portion 43 is stably inserted into the connection groove 12.

Specifically, in this embodiment, a radial dimension of the first cover portion 42 is slightly smaller than the radial dimension of the opening 121, facilitating quick insertion of the first cover portion 42 into the opening 121. An end of the first cover portion 42 away from the second cover portion 43 is fixedly connected to the end of the main body 1 provided with the connection groove 12 by seam welding.

Referring to FIGS. 1 to 4, the driven gear portion 34 includes a plurality of driven teeth 341 arranged around the first shaft portion 32 at intervals on an end face of the limit portion 31 facing the opening 121. This arrangement is conducive to a tighter meshing connection between the drive gear portion 20 and the driven gear portion 34 during the rotation of the first rotating body 2.

Referring to FIGS. 1 to 4, the main body 1 includes a handle 13 and a housing 14. The handle 13 includes a first part 131 and a second part 132 along the length direction. The first part 131 is provided with a mounting groove 133. The second part 132 includes a base portion 1321 connected to the first part 131 and a boss 1322 extending upward from a middle part of an end of the base portion 1321 away from the first part 131. A first shoulder 1323 is formed between the boss 1322 and the base portion 1321. The second part 132 is provided with a first mounting hole 1324 extending along the length direction of the handle 13 and penetrating through the base portion 1321 and the boss 1322, and one end of the first mounting hole 1324 is communicated with the mounting groove 133.

The housing 14 is provided with a second mounting hole 141 and the connection groove 12 which penetrate outward in different directions and communicate with each other. The boss 1322 is adaptively inserted into one end of the second mounting hole 141 away from the connection groove 12. An end of a side wall of the housing 14 defining the second mounting hole 141 is disposed on the first shoulder 1323. The mounting groove 133, the first mounting hole 1324, and the second mounting hole 141, which communicate sequentially along the length direction of the main body 1, form the connection hole 11.

The first rotating body 2 includes a shaft portion 21 and a head portion 22. The shaft portion 21 is extended from a middle part of one end of the head portion 22. A second shoulder 23 is formed between the head portion 22 and the shaft portion 21. An end of the head portion 22 away from the shaft portion 21 forms the drive gear portion 20. The head portion 22 is inserted into an end of the second mounting hole 141 near the connection groove 12 with a clearance fit. The second shoulder 23 abuts against an end face of the boss 1322. The shaft portion 21 is disposed through the first mounting hole 1324 and the mounting groove 133 with a clearance fit.

In the above structure, the boss 1322 of the handle 13 is tightly inserted into the second mounting hole 141 of the housing 14. The head portion 22 of the first rotating body 2 fits in the second mounting hole 141 with clearance. The second shoulder 23 formed between the head portion 22 and the shaft portion 21 of the first rotating body 2 abuts against the end face of the boss 1322. The shaft portion 21 fits in the first mounting hole 1324 with clearance. In such an arrangement, the handle 13, the housing 14, and the first rotating body 2 form a nested structure, which can effectively improve the installation stability and rotational accuracy of the first rotating body 2, improve the smoothness of the transmission cooperation between the first rotating body 2 and the second rotating body 3, and thereby reduce the noise of the assembly during operation.

Referring to FIGS. 1 to 4, in this embodiment, the housing 14 includes a first connection portion 142 extending along a first direction A and a second connection portion 143 extending along a second direction B. The first connection portion 142 is provided with the second mounting hole 141 having a first central axis 101. The second connection portion 143 is provided with the connection groove 12 having a second central axis 102. An angle between the first central axis 101 and the second central axis 102 is 90 degrees, which is conducive to forming a tight fit between the drive gear portion 20 and the driven gear portion 34, and improves the smoothness of the transmission cooperation between the second rotating body 3 and the first rotating body 2.

Specifically, in this embodiment, the first mounting hole 1324 has a third central axis 103. The rotation axis of the first rotating body 2 is coaxial with the first central axis 101 and the third central axis 103, and the rotation axis of the second rotating body 3 is coaxial with the second central axis 102.

As shown in this embodiment, the drive gear portion 20 includes a plurality of drive teeth 201 arranged at intervals along the circumference at the end of the head portion 22 away from the shaft portion 21. The end of the head portion 22 provided with the drive teeth 201 extends into the connection groove 12, so that the drive teeth 201 and the driven teeth 341 are meshed and connected.

Referring to FIGS. 1 to 4, the shaft portion 21 includes a first cylindrical part 212 and a second cylindrical part 213. One end of the first cylindrical part 212 is connected to an end of the head portion 22 away from the drive gear portion 20, and the other end is connected to the second cylindrical part 213. A radial dimension of the second cylindrical part 213 is smaller than a radial dimension of the first cylindrical part 212, thereby facilitating the quick insertion of the shaft portion 21 into the first mounting hole 1324.

Furthermore, a conical transition surface 214 is formed at the connection between the first cylindrical part 212 and the second cylindrical part 213, providing a transition guide from the second cylindrical part 213 to the first cylindrical part 212 when the shaft portion 21 is inserted into the first mounting hole 1324.

Furthermore, an axial dimension of the first mounting hole 1324 is greater than an axial dimension of the head portion 22, which is conducive to further improving the installation stability and rotational accuracy of the first rotating body 2.

Furthermore, the end of the side wall of the housing 14 defining the second mounting hole 141 is fixedly connected to the base portion 1321 by seam welding, which is conducive to a stable connection between the housing 14 and the handle 13.

Furthermore, the first part 131 includes a grip portion 1311 connected to the base portion 1321. The mounting groove 133 is provided at an end of the grip portion 1311 away from the base portion 1321, and a radial dimension of said end of the grip portion 1311 is greater than a radial dimension of the base portion 1321. An outer side wall of an end of the grip portion 1311 connected to the base portion 1321 is formed with a transitional conical surface 1312.

Specifically, in this embodiment, the grip portion 1311, the base portion 1321, and the boss 1322 are an integral structure. In some embodiments, the grip portion 1311, the base portion 1321, and the boss 1322 can also be separate components joined together by other means, including but not limited to mechanical fasteners, structural threads, adhesives, or ultrasonic welding.

Referring to FIGS. 1 to 4, the present invention discloses a dental cleaning device including the handpiece assembly for a dental cleaning device as described above; a dental cleaning member 5 connected to the second rotating body 3; and a drive assembly connected to the first rotating body 2, to drive the first rotating body 2 to rotate.

Specifically, in this embodiment, the dental cleaning member 5 includes a dental polishing member. The drive assembly includes a rotary drive motor, whose drive end is disposed in the mounting groove 133 and connected to the second cylindrical part 213 of the first rotating body 2, so as to drive the second rotating body 3 to drive the dental cleaning member 5 to rotate by driving the first rotating body 2 to rotate.

The embodiments disclosed above are merely preferred embodiments of the present application and are not intended to limit the scope of the rights of the present application. Therefore, equivalent variations made based on the claims of the present application shall fall within the scope of the present application.

What is claimed is:

1. A handpiece assembly for a dental cleaning device, comprising:
a main body, having a connection hole extending along a length direction thereof and a connection groove located at one end thereof, wherein the connection groove communicates with the connection hole and forms an opening facing one side of the main body, a middle portion of a bottom wall of the connection groove, which is away from the opening, is provided with a first shaft hole penetrating outwards;
a first rotating body, rotatably disposed in the connection hole, wherein an end of the first rotating body facing the connection groove is provided with a drive gear portion;
a second rotating body, comprising a limit portion, a first shaft portion, a second shaft portion, and a driven gear portion, wherein the first shaft portion and the second shaft portion are extended outwards from opposite ends of the limit portion respectively, the limit portion, the first shaft portion, and the driven gear portion are disposed in the connection groove, the limit portion is abutted against the bottom wall of the connection groove, the driven gear portion is meshed with the drive gear portion so that rotation of the first rotating body is transferred to the second rotating body with a changed direction, the second shaft portion is disposed in the first shaft hole with a clearance fit, and an end of the second shaft portion away from the limit portion is configured to connect to a dental cleaning member to drive the dental cleaning member to rotate; and
a cover, fixedly mounted over the opening, wherein an inner wall of the cover is provided with a second shaft hole, and a terminal end of the first shaft portion is inserted into the second shaft hole with a clearance fit.

2. The handpiece assembly for a dental cleaning device according to claim 1, wherein a threaded hole is formed inwardly at the end of the second shaft portion away from the limit portion, a threaded post is extended outwardly from one end of the dental cleaning member and threadedly connected to the threaded hole, thereby connecting the dental cleaning member to the second shaft portion.

3. The handpiece assembly for a dental cleaning device according to claim 1, wherein the cover comprises a first cover portion and a second cover portion, the second cover portion is extended from a middle part of one end of the first cover portion, and a middle part of an end of the second cover portion facing the connection groove is inwardly provided with the second shaft hole;
a radial dimension of the opening is greater than a radial dimension of the connection groove, so that a limit surface is formed in the opening, the limit surface being orthogonally connected to both an inner side wall of the opening and an inner side wall of the connection groove;
the second cover portion is adaptively inserted into an end of the connection groove away from the first shaft hole, and an edge of the first cover portion is abutted against the limit surface.

4. The handpiece assembly for a dental cleaning device according to claim 1, wherein the driven gear portion comprises a plurality of driven teeth arranged around the first shaft portion at intervals on an end face of the limit portion facing the opening.

5. The handpiece assembly for a dental cleaning device according to claim 1, wherein the main body comprises:
a handle, comprising a first part and a second part extended along the length direction, wherein the first part is provided with a mounting groove, the second part comprises a base portion connected to the first part and a boss extending upward from a middle part of an end of the base portion away from the first part, a first shoulder is formed between the boss and the base portion, the second part is provided with a first mounting hole extending along the length direction of the handle and penetrating through the base portion and the boss, and one end of the first mounting hole communicates with the mounting groove; and
a housing, provided with a second mounting hole and the connection groove which penetrate outward in different directions and communicate with each other, wherein the boss is adaptively inserted into one end of the second mounting hole away from the connection groove, an end of a side wall of the housing defining the second mounting hole is disposed on the first shoulder; the mounting groove, the first mounting hole, and the second mounting hole, which communicate sequentially along the length direction of the main body, form the connection hole;
wherein the first rotating body comprises a shaft portion and a head portion, the shaft portion is extended from a middle part of one end of the head portion, a second shoulder is formed between the head portion and the shaft portion, an end of the head portion away from the shaft portion forms the drive gear portion, the head portion is inserted into an end of the second mounting hole near the connection groove with a clearance fit, the second shoulder is abutted against an end face of the boss, and the shaft portion is disposed through the first mounting hole and the mounting groove with a clearance fit.

6. The handpiece assembly for a dental cleaning device according to claim 5, wherein the shaft portion comprises a first cylindrical part and a second cylindrical part, one end of the first cylindrical part is connected to an end of the head portion away from the drive gear portion, another end of the first cylindrical part is connected to the second cylindrical part, and a radial dimension of the second cylindrical part is smaller than a radial dimension of the first cylindrical part.

7. The handpiece assembly for a dental cleaning device according to claim 5, wherein an axial dimension of the first mounting hole is greater than an axial dimension of the head portion.

8. The handpiece assembly for a dental cleaning device according to claim 5, wherein the end of the side wall of the housing defining the second mounting hole is fixedly connected to the base portion by seam welding.

9. The handpiece assembly for a dental cleaning device according to claim 5, wherein the first part comprises a grip portion connected to the base portion, the mounting groove is provided at an end of the grip portion away from the base portion, and a radial dimension of said end of the grip portion is greater than a radial dimension of the base portion, and an outer side wall of an end of the grip portion connected to the base portion is formed with a transitional conical surface.

10. A dental cleaning device, comprising:
the handpiece assembly for a dental cleaning device according to claim 1;
a dental cleaning member connected to the second rotating body; and
a drive assembly connected to the first rotating body, and the drive assembly being configured to drive the first rotating body to rotate.

11. The dental cleaning device according to claim 10, wherein a threaded hole is formed inwardly at the end of the second shaft portion away from the limit portion, a threaded post is extended outwardly from one end of the dental cleaning member and threadedly connected to the threaded hole, thereby connecting the dental cleaning member to the second shaft portion.

12. The dental cleaning device according to claim 10, wherein the cover comprises a first cover portion and a second cover portion, the second cover portion is extended from a middle part of one end of the first cover portion, and a middle part of an end of the second cover portion facing the connection groove is inwardly provided with the second shaft hole;
a radial dimension of the opening is greater than a radial dimension of the connection groove, so that a limit surface is formed in the opening, the limit surface being orthogonally connected to both an inner side wall of the opening and an inner side wall of the connection groove;
the second cover portion is adaptively inserted into an end of the connection groove away from the first shaft hole, and an edge of the first cover portion is abutted against the limit surface.

13. The dental cleaning device according to claim 10, wherein the driven gear portion comprises a plurality of driven teeth arranged around the first shaft portion at intervals on an end face of the limit portion facing the opening.

14. The dental cleaning device according to claim 10, wherein the main body comprises:
a handle, comprising a first part and a second part extended along the length direction, wherein the first part is provided with a mounting groove, the second part comprises a base portion connected to the first part and a boss extending upward from a middle part of an end of the base portion away from the first part, a first shoulder is formed between the boss and the base portion, the second part is provided with a first mounting hole extending along the length direction of the handle and penetrating through the base portion and the boss, and one end of the first mounting hole communicates with the mounting groove; and
a housing, provided with a second mounting hole and the connection groove which penetrate outward in different directions and communicate with each other, wherein the boss is adaptively inserted into one end of the second mounting hole away from the connection groove, an end of a side wall of the housing defining the second mounting hole is disposed on the first shoulder; the mounting groove, the first mounting hole, and the second mounting hole, which communicate sequentially along the length direction of the main body, form the connection hole;
wherein the first rotating body comprises a shaft portion and a head portion, the shaft portion is extended from a middle part of one end of the head portion, a second shoulder is formed between the head portion and the shaft portion, an end of the head portion away from the shaft portion forms the drive gear portion, the head portion is inserted into an end of the second mounting hole near the connection groove with a clearance fit, the second shoulder is abutted against an end face of the boss, and the shaft portion is disposed through the first mounting hole and the mounting groove with a clearance fit.

15. The dental cleaning device according to claim 14, wherein the shaft portion comprises a first cylindrical part and a second cylindrical part, one end of the first cylindrical part is connected to an end of the head portion away from the drive gear portion, another end of the first cylindrical part is connected to the second cylindrical part, and a radial dimension of the second cylindrical part is smaller than a radial dimension of the first cylindrical part.

16. The dental cleaning device according to claim 14, wherein an axial dimension of the first mounting hole is greater than an axial dimension of the head portion.

17. The dental cleaning device according to claim 14, wherein the end of the side wall of the housing defining the second mounting hole is fixedly connected to the base portion by seam welding.

18. The dental cleaning device according to claim 14, wherein the first part comprises a grip portion connected to the base portion, the mounting groove is provided at an end of the grip portion away from the base portion, and a radial dimension of said end of the grip portion is greater than a radial dimension of the base portion, and an outer side wall of an end of the grip portion connected to the base portion is formed with a transitional conical surface.
